(19) United States
(12) Patent Application Publication
(10) Pub. No.: US 2011/0190421 A1
(43) Pub. Date: Aug. 4, 2011

(54) ADHESIVE COMPOSITION FOR PRODUCING SEMICONDUCTOR DEVICE, AND ADHESIVE SHEET FOR PRODUCING SEMICONDUCTOR DEVICE

(76) Inventors: Yuta KIMURA, Osaka (JP); Yasushi INOUE, Osaka (JP); Takeshi MATSUMURA, Osaka (JP); Kenji OONISHI, Osaka (JP); Yuichiro SHISHIDO, Osaka (JP)

(21) Appl. No.: 13/018,619

(22) Filed: Feb. 1, 2011

(30) Foreign Application Priority Data
Feb. 2, 2010 (JP) 2010-021452

(51) Int. Cl. C08L 63/00

(52) U.S. Cl. 523/466

(57) ABSTRACT

Provided is an adhesive composition into which an additive for capturing a cation is incorporated, thereby making it possible to form a semiconductor-device-producing adhesive sheet capable of preventing deterioration of the electrical characteristic of a produced semiconductor device so as to improve the product reliability of the device. An adhesive composition, for producing a semiconductor device, which contains at least an additive for capturing a cation.

### BACKGROUND OF THE INVENTION

1. Field of the Invention

The present invention relates to an adhesive composition for producing a semiconductor device, and an adhesive sheet for producing a semiconductor device.

2. Description of the Related Art

In recent years, stacked multi chip packages have been spread, wherein memory package chips for portable telephones or portable audio instruments are stacked into a multi-level. With progress in image processing technique or multi-functionalization of portable telephones and other instruments, an increase in the density and the integration degree of packages therefor has been promoted, as well as a decrease in the thickness thereof.

Meanwhile, when a cation (for example, a copper ion or iron ion) is mixed from the outside into a crystal substrate of a wafer in any process for semiconductor-production and then the cation reaches a circuit-forming area formed in the upper surface of the wafer, there is caused a problem that the electrical characteristic thereof is declined. When a semiconductor product is used, there is also caused a problem that a cation is generated from its circuit or wires so that the electrical characteristic is deteriorated.

Against the problems, the following attempts have been hitherto made: extrinsic gettering of working the rear surface of a wafer to form a fractured layer (strain), and capturing cations by the fractured layer so as to remove the cations (the gettering may be abbreviated to “EG” hereinafter); and intrinsic gettering of forming oxygen-precipitated defects in a crystal substrate of a wafer, and capturing cations by the oxygen-precipitated defects to remove the cations (the gettering may be abbreviated to “IG” hereinafter).

However, as the wafers have become thinner in recent years, advantageous effects of IG have been become smaller. Additionally, by removing strain in the rear surface of a wafer, which causes a crack or warp of the wafer, advantageous effects of EG come not to be gained. For these reasons, there has been a problem that sufficient advantageous effects of the getterings come not to be gained.

Hitherto, as a method for bonding semiconductor elements onto a substrate or the like, the following have been suggested: a method using a thermosetting paste resin (see, for example, JP 2002-179769 A); or a method using an adhesive sheet wherein a thermoplastic resin and a thermosetting resin are used together with each other (see, for example, JP 2000-104040 A). Moreover, as an adhesive sheet, suggested has been hitherto an adhesive sheet in which an anion exchanger is incorporated so as to capture a chloride ion, which causes corrosion of wires, thereby producing improved connection reliability (see, for example, JP 2009-256630 A).

### SUMMARY OF THE INVENTION

In light of the problems, the invention has been made. An object thereof is to provide an adhesive composition of/from which a semiconductor-device-producing adhesive sheet can be made, the sheet being a sheet wherein a cation mixed from the outside in a semiconductor-device-producing process is captured, thereby preventing deterioration in the electrical characteristic of a produced semiconductor device so as to improve the product reliability of the device; and such an adhesive sheet.

In order to solve the problems in the prior art, the inventors have investigated semiconductor-device-producing adhesive compositions, and semiconductor-device-producing adhesive sheets. As a result, the inventors have found out that when an additive for capturing a cation is incorporated into a composition, a semiconductor-device-producing adhesive sheet can be obtained which can prevent deterioration of the electrical characteristic of a semiconductor device produced by use of this sheet so as to improve the product reliability of the device. Thus, the invention has been made.

Accordingly, the adhesive composition of the invention for producing a semiconductor device contains at least an additive for capturing a cation.

According to the composition, at least the cation-capturing additive is contained; thus, an adhesive sheet formed by use of the semiconductor-device-producing adhesive composition can capture a cation mixed from the outside in various processes in the production of a semiconductor device. As a result, the cation mixed from the outside does not easily reach a circuit-forming area formed in the upper surface of a wafer; thus, deterioration of the electrical characteristic can be restrained so that the product reliability of the device is improved. About the adhesive sheet disclosed in JP 2009-256630 A, an anion exchanger is added thereto for capturing a chloride ion, which corrodes copper wiring; however, no additive for capturing any cation is added thereto.

In the composition, it is preferred that the additive is a cation exchanger or a complexing compound. The use of the cation exchanger or complexing compound as the additive makes it possible to capture a cation satisfactorily.

In the composition, it is preferred from the viewpoint of the attainment of more satisfactory cation-capturing that the cation exchanger is an inorganic cation exchanger.

In the composition, it is preferred from the viewpoint of the attainment of even more satisfactory cation-capturing that the inorganic cation exchanger is an oxidized hydrate of an element selected from the group consisting of antimony, bismuth, zirconium, titanium, tin, magnesium, and aluminum.

In the composition, it is preferred from the viewpoint of dispersibility and adhesive property that the inorganic cation exchanger has an average particle diameter of 0.05 to 20 μm. When the average particle diameter of the inorganic cation exchanger is set to 20 μm or less, a decline in the adhesive force can be restrained. When the diameter is set to 0.05 μam or more, the dispersibility can be improved.

In the composition, it is preferred from the viewpoint of the attainment of more satisfactory cation-capturing that the complexing compound is an organic complexing compound. The complexing compound is in particular preferably one or more selected from the group consisting of a nitrogen-containing compound, a hydroxyl-containing compound, and a carboxyl-containing compound.

In the composition, it is preferred from the viewpoint of the attainment of even more satisfactory cation-capturing that the nitrogen-containing compound is one or more selected from the group consisting of triazole compounds, tetrazole compounds, and bipyridyl compounds.

In the composition, it is preferred from the viewpoint of the attainment of even more satisfactory cation-capturing that the hydroxyl-containing compound is one or more selected from the group consisting of quinol compounds, hydroxyanthraquinone compounds, and polyphenolic compounds.

In the composition, it is preferred from the viewpoint of the attainment of even more satisfactory cation-capturing that the carboxyl-containing compound is one or more selected from the group consisting of carboxyl-containing aromatic compounds, and carboxyl-containing aliphatic compounds.

In the composition, it is preferred that the content of the additive ranges from 0.1 to 80 parts by weight for 100 parts by weight of the adhesive composition. When the content is set to 0.1 part or more by weight, a cation (in particular, a copper ion) can be more effectively captured. When the content is set to 80 parts or less by weight, a fall in the heat resistance and an increase in costs can be restrained.

The adhesive sheet according to the invention, for producing a semiconductor device, is characterized by forming by use of the above-mentioned adhesive composition. Since the adhesive composition contains at least the cation-capturing additive, the adhesive sheet formed by use of the adhesive composition can capture a cation mixed from the outside in various processes in the production of a semiconductor device. As a result, the cation mixed from the outside does not easily reach a circuit-forming area formed in the upper surface of a wafer. Thus, deterioration of the electrical characteristic can be restrained so that the product reliability can be improved.

The adhesive composition of the invention for producing a semiconductor device is a semiconductor-device-producing adhesive composition which contains at least an additive for capturing a cation (the composition may be referred to merely as the “adhesive composition” hereinafter).

Examples of the cation-capturing additive include a cation exchanger and a complexing compound. Of these substances, a cation exchanger is preferred since the exchanger is excellent in heat resistance. A complexing compound is more preferred since a cation can be satisfactorily captured.

The cation exchanger is preferably an inorganic cation exchanger from the viewpoint of the attainment of more satisfactory cation-capturing.

In the invention, the cation captured by the cation-capturing additive is not particularly limited as far as the cation is a cation. Examples thereof include Na, K, Ni, Cu, Cr, Co, Hf, Pt, Ca, Ba, Sr, Fe, Al, Ti, Zn, Mo, Mn, and V ions.

### Inorganic Cation Exchanger:

The inorganic cation exchanger is not particularly limited, and may be an inorganic cation exchanger known in the prior art. From the viewpoint of the attainment of more satisfactory cation-capturing, the inorganic cation exchanger is, for example, an oxidized hydrate of an element selected from the group consisting of antimony, bismuth, zirconium, titanium, tin, magnesium, and aluminum. These may be used alone or in combination of two or more thereof. The inorganic cation exchanger is in particular preferably an oxidized hydrate of magnesium or aluminum.

Commercially available products of the inorganic cation exchanger may be products manufactured by Toagosei Co., Ltd., examples of trade names thereof including IXE-700F, IXE-770, IXE-770D, IXE-2116, IXE-100, IXE-300, IXE-600, IXE-633, IXE-6107, and IXE-6136.

The average particle diameter of the inorganic cation exchanger is preferably from 0.05 to 20 more preferably from 0.1 to 10 μm. When the average particle diameter of the inorganic cation exchanger is set to 20 μm or less, a decline in the adhesive force can be restrained. When the diameter is set to 0.05 μm, the dispersibility can be improved.

### Complexing Compound:

The complexing compound is not particularly limited as far as the compound is a compound which is complexed with a cation. The complexing compound is preferably an organic complexing compound. The organic complexing compound is preferably one or more selected from the group consisting of a nitrogen-containing compound, a hydroxyl-containing compound, and a carboxyl-containing compound from the viewpoint of the attainment of satisfactory cation-capturing.

### Nitrogen-Containing Compound:

The nitrogen-containing compound is preferably a compound in a fine powdery form, a compound easily soluble in an organic solvent, or a compound in a liquid form. The nitrogen-containing compound may be a triazole compound, a tetrazole compound, or a bipyridyl compound from the viewpoint of the attainment of more satisfactory cation-capturing. The nitrogen-containing compound is more preferably a triazole compound from the viewpoint of the stability of a complex formed with a copper ion. These compounds may be used alone or in combination of two or more thereof.

The triazole compound is not particularly limited, and examples thereof include 1,2,3-benzotriazole, 1-{N,N-bis(2-ethylhexyl)aminomethyl}benzotriazole, carboxybenzotriazole, 2-{2′-hydroxy-5′-methylphenyl}benzotriazole, 2-{2′-hydroxy-3′,5′-di-t-butylphenyl}-5chlorobenzotriazole, 2-{2′-hydroxy-3′-t-butyl-5′-methylphenyl}-5-chlorobenzotriazole, 2-{2′-hydroxy-3′,5′-di-t-amylphenyl}benzotriazole, 2-{2′-hydroxy-5′-t-octylphenyl}benzotriazole, 6-(2-benzotriazolyl)-4-t-octyl-6′-t-butyl-4′-methyl-2,2′-methylenebisphenol, 1-(2′,3′-hydroxypropyl)benzotriazole, 1-(1′,2′-dicarobxydiethyl)benzotriazole, 1-(2-ethylhexylaminomethyl)benzotriazole, 2,4-di-t-bentyl-6-{(H-benzotriazole-1-yl)methyl}phenol, 2-(2-hydroxy-5-t-butylphenyl)-2H-benzotriazole, 3-(2H-benzotriazole-2-yl)-5-(1,1-dimethylethyl)-4-hydroxy, octyl-3-[3-tert-butyl-4-hydroxy-5-(5-chloro-2H-benzotriazol e-2-yl)phenyl]propionate, 2-ethylhexyl 3-[3-tert-butyl-4-hydroxy-5-(5-chloro-2H-benzotriazole-2-yl) phenylpropionate, 2-(2H-benzotriazole-2-yl)-6-(1-methyl-1-phenylethyl)-4-1,1,3,3-tetramethylbutyl)phenol, 2-(2H-benzotriazole-2-yl)-4-t-butylphenol, 2-(2′-hydroxy-5′-methylphenyl)benzotriazole, 2-(2′-hydroxy-5′-t-octylphenyl)-benzotriazole, 2-(3′-t-butyl-2′-hydroxy-5′-methylphenyl)-5-chlorobenzotriazole, 2-(2′-hydroxy-3′,5′-di-t-amylphenyl)benzotriazole, 2-(2′-hydroxy-3′,5′-di-t-butylphenyl)-5-chlorobenzotriazole, 2-[2′-hydroxy-3,5-di(1,1-dimethylbenzyl)phenyl]-2H-benzotriazole, 2,2′-methylenebis[6-(2H-benzotriazole-2-yl)-4-(1,1,3,3-tetramethylbutyl)phenol], (2-[2-hydroxy-3,5-bis(α,α-dimethylbenzyl)phenyl]-2H-benzotriazole, and methyl 3-(3-(2H-benzotriazole-2-yl)-5-t-butyl-4-hydroxyphenyl)propionate.

Commercially available product of the triazole compound may be used without especial limitation, and may be compounds manufactured by Johoku Chemical Co., Ltd., examples of trade names thereof including BT-120, BT-LX, CBT-1, JF-77, JF-78, JF-79, JF-80, JF83, JAST-500, BT-GL, BT-M, BT-260, and BT-365; products manufactured by BASF, examples of trade names thereof including TINUVIN PS, TINUVIN P, TINUVIN P FL, TINUVIN 99-2, TINUVIN 109, TINUVIN 900, TINUVIN 928, TINUVIN 234, TINUVIN 329, TINUVIN 329 FL, TINUVIN 326, TINUVIN 326 FL, TINUVIN 571, and TINUVIN 213; and products manufactured by Everlight Chemical Industrial Corp., examples of trade names thereof include EVESORB 81, EVESORB 109, EVESORB 70, EVESORB 71, EVESORB 72, EVESORB 73, EVESORB 74, EVESORB 75, EVESORB 76, EVESORB 78, and EVESORB 80. Triazole compounds are each used also as an antirust agent.

The tetrazole compound is not particularly limited, and may be, for example, 5-amino-1H-tetrazole.

The bipyridyl compound is not particularly limited, and may be, for example, 2,2′-bipyridyl, or 1,10-phenanthroline.

### Hydroxyl-Containing Compound:

The hydroxyl-containing compound is not particularly limited, and is preferably a compound in a fine powdery form, a compound easily soluble in an organic solvent, or a compound in a liquid form. The hydroxyl-containing compound may be a quinol compound, a hydroxyanthraquinone compound, or a polyphenolic compound from the viewpoint of the attainment of more satisfactory cation-capturing. A polyphenolic compound is more preferred from the viewpoint of the stability of a complex with a copper ion. These compounds may be used alone or in combination of two or more thereof.

The quinol compound is not particularly limited, and may be, for example, 1,2-benzenediol.

The hydroxyanthraquinone compound is not particularly limited, and may be, for example, alizarin, or Anthrarufin.

The polyphenolic compound is not particularly limited, and may be, for example, tannin, and a tannin derivative (such as gallic acid, methyl gallate, and pyrogallol).

### Carboxyl-Containing Compound:

The carboxyl-containing compound is not particularly limited, and may be, for example, a carboxyl-containing aromatic compound and a carboxyl-containing aliphatic compound.

The carboxyl-containing aromatic compound is not particularly limited, and may be, for example, phthalic acid, picolinic acid and pyrrole-2-carboxylic acid.

The carboxyl-containing aliphatic compound is not particularly limited, and may be, for example, a higher aliphatic acid and a carboxylic acid chelating reagent.

Commercially available products of the carboxylic acid chelating reagent maybe used without especial limitation. The products may be products manufactured by Chelest Corp., examples of trade names thereof including CHELEST A, CHELEST 110, CHELEST B, CHELEST 200, CHELEST C, CHELEST D, CHELEST 400, CHELEST 40, CHELEST OD, CHELEST NTA, CHELEST 700, CHELEST PA, CHELEST HA, CHELEST MZ-2, CHELEST MZ-4A, and CHELEST MZ-8.

The blend amount of the cation-capturing additive is preferably from 0.1 to 80 parts by weight, more preferably from 0.1 to 50 parts by weight, even more preferably from 0.1 to 20 parts by weight for 100 parts by weight of the adhesive composition. When the amount is set to 0.1 part or more by weight, a cation (in particular, a copper ion) can be effectively captured. When the amount is set to 80 parts or less by weight, a fall in the heat resistance or an increase in costs can be restrained.

It is preferred that the adhesive composition contains a thermoplastic resin. It is also preferred that the composition contains a thermoplastic resin and a thermosetting resin. Examples of the thermosetting resin include phenolic resin, amino resin, unsaturated polyester resin, epoxy resin, polyurethane resin, silicone resin, and thermosetting polyimide resin. These resins may be used alone or in combination of two or more thereof. It is particularly preferred to use at least either of epoxy resin or phenolic resin.

The epoxy resin is not particularly limited as far as the resin is ordinarily used as an adhesive composition. Examples thereof include bisphenol A type, bisphenol F type, bisphenol S type, brominated bisphenol A type, hydrogenated bisphenol A type, bisphenol AF type, biphenyl type, naphthalene type, fluorene type, phenol novolak type, o-cresol novolak type, trishydroxyphenylmethane type, tetraphenylol ethane type, and other type bifunctional or polyfunctional epoxy resins; and hydantoin type, trisglycidylisocyanurate type and glycidylamine type epoxy resins. These may be used alone or in combination of two or more thereof. Of these epoxy resins, particularly preferred are novolak type, biphenyl type, trishydroxyphenylmethane type, and tetraphenylol ethane type epoxy resins since these resins are rich in reactivity with phenolic resin as a curing agent, and are excellent in heat resistance and other properties.

The phenolic resin is a resin acting as a curing agent for the epoxy resin. Examples thereof include phenol novolak resin, phenol aralkyl resin, cresol novolak resin, tert-butylphenol novolak resin, nonylphenol novolak resin, and others novolak type resins; resol type phenolic resins; and polyoxystyrenes such as polyparaoxystyrene. These maybe used alone or in combination of two or more thereof. Of these phenolic resins, particularly preferred are phenol novolak resin and phenol aralkyl resin since the resins improve the connection reliability of a semiconductor device.

The blend ratio between the epoxy resin and the phenolic resin is preferable to set the amount of the hydroxyl groups in the phenolic resin appropriately into the range of 0.5 to 2.0 equivalents per equivalent of the epoxy groups in the epoxy resin component, more preferably into the range of 0.8 to 1.2 equivalents per equivalent thereof. In other words, if the blend ratio between the two is out of the range, a sufficient curing reaction does not proceed so that properties of the epoxy resin cured product are easily deteriorated.

Examples of the thermoplastic resin include natural rubber, butyl rubber, isoprene rubber, chloroprene rubber, ethylene/vinyl acetate copolymer, ethylene/acrylic acid copolymer, ethylene/acrylic ester copolymer, polybutadiene resin, polycarbonate resin, thermoplastic polyimide resin, polyamide resins such as 6-nylon and 6,6-nylon, phenoxy resin, acrylic resin, saturated polyester resins such as PET and PBT, polyamideimide resin, and fluorine-contained resin. These thermoplastic resins may be used alone or in combination of two or more thereof. Of these thermoplastic resins, acrylic resin is particularly preferable since the resin contains ionic impurities in only a small amount and has a high heat resistance so as to make it possible to ensure the reliability of the semiconductor element.

The acrylic resin is not limited to any especial kind, and may be, for example, a polymer comprising, as a component or components, one or more esters of acrylic acid or methacrylic acid having a linear or branched alkyl group having 30 or less carbon atoms, in particular, 4 to 18 carbon atoms. Examples of the alkyl group include methyl, ethyl, propyl, isopropyl, n-butyl, t-butyl, isobutyl, amyl, isoamyl, hexyl, heptyl, cyclohexyl, 2-ethylhexyl, octyl, isooctyl, nonyl, isononyl, decyl, isodecyl, undecyl, lauryl, tridecyl, tetradecyl, stearyl, octadecyl, and dodecyl groups.

A different monomer which constitutes the above-mentioned polymer is not limited to any especial kind, and examples thereof include carboxyl-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl-containing monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)methylacrylate; monomers which contain a sulfonic acid group, such as styrenesulfonic acid, allylsulfonic acid, 2-(meth)acrylamide-2-methylpropanesulfonic acid, (meth)acrylamidepropane sulfonic acid, sulfopropyl(meth)acrylate, and (meth)acryloyloxynaphthalenesulfonic acid; and monomers which contain a phosphoric acid group, such as 2-hydroxyethylacryloyl phosphate.

The content by percentage of the thermosetting resin is not particularly limited as far as the film made of the composition exhibits a function as a thermosetting film at the time of heating the film under predetermined conditions. The content by percentage is preferably from 5 to 60% by weight, more preferably from 10 to 50% by weight.

About the adhesive composition, it is preferred that the composition contains epoxy resin, phenolic resin and acrylic resin and the total amount of the epoxy resin and the phenolic resin is from 10 to 2000 parts by weight for 100 parts by weight of the acrylic resin. The amount is more preferably from 10 to 1500 parts by weight, even more preferably from 10 to 1000 parts by weight. When the total amount of the epoxy resin and the phenolic resin is set to 10 parts or more by weight for 100 parts by weight of the acrylic resin, the composition can gain a bonding effect when cured, so that peeling from the sheet made of the composition can be restrained. When the total amount is set to 2000 parts or less by weight, the following can be restrained: the sheet gets brittle so as to produce a low operability.

When the adhesive sheet formed by use of the adhesive composition is beforehand crosslinked into some degree, it is preferred to add, as a crosslinking agent, a polyfunctional compound reactive with functional groups or others at terminals of molecular chains of the polymer(s) to the composition. This manner makes it possible to improve the adhesive property at high temperatures and improve the heat resistance.

The crosslinking agent may be one known in the prior art. Particularly preferable are polyisocyanate compounds, such as tolylene diisocyanate, diphenylmethane diisocyanate, p-phenylene diisocyanate, 1,5-naphthalene diisocyanate, and adducts of polyhydric alcohol and diisocyanate. The amount of the crosslinking agent to be added is preferably set to 0.05 to 7 parts by weight for 100 parts by weight of the above-mentioned polymer. If the amount of the crosslinking agent to be added is more than 7 parts by weight, the adhesive force is unfavorably lowered. On the other hand, if the adding amount is less than 0.05 part by weight, the cohesive force is unfavorably insufficient. A different polyfunctional compound, such as an epoxy resin, together with the polyisocyanate compound may be incorporated if necessary.

A filler may be appropriately incorporated into the adhesive composition in accordance with the purpose of the composition. The incorporation of the filler makes it possible to give electroconductivity to the adhesive sheet obtained from the adhesive composition, improve the thermal conductivity thereof, adjust the elastic modulus. The filler may be an inorganic filler or an organic filler. The filler is preferably an inorganic filler from the viewpoint of an improvement in the handleability, an improvement in the thermal conductivity, the adjustment of the melt viscosity, the supply of thixotropy to the composition, and others. The inorganic filler is not particularly limited, and examples thereof include aluminum hydroxide, magnesium hydroxide, calcium carbonate, magnesium carbonate, calcium silicate, magnesium silicate, calcium oxide, magnesium oxide, aluminum oxide, aluminum nitride, aluminum borate whisker, boron nitride, crystalline silica, and non-crystalline silica. These may be used alone or in combination of two or more thereof. From the viewpoint of an improvement in the thermal conductivity, preferred are aluminum oxide, aluminum nitride, boron nitride, crystalline silica, and non-crystalline silica. From the viewpoint of a good balance between the above-mentioned individual properties, preferred is crystalline silica or non-crystalline silica. In order to attain the supply of electroconductivity thereto, an improvement in the thermal conductivity, and others, an electroconductive material (electroconductive filler) may be used as the inorganic filler. The electroconductive filler includes metallic powder of silver, aluminum, gold, copper, nickel, electroconductive alloy in a spherical form, a needle form, or a flake form, a metal oxide such as alumina, amorphous carbon black, and graphite.

The average particle diameter of the filler may be set into the range of 0.005 to 10 μm. When the average particle diameter of the filler is set to 0.005 μm or more, the wettability of the adhesive composition to an adherend and the adhesive property of the adhesive composition can be better. When the average particle diameter is set to 10 μm or less, the advantageous effects of the filler added to produce the above-mentioned individual properties can be made sufficient and further the composition can keep heat resistance certainly. The average particle diameter of the filler is a value obtained by use of, for example, a light-intensity particle size distribution meter (instrument name: LA-910, manufactured by Horiba Ltd.).

Besides the cation-capturing additive, some other additive may be appropriately incorporated into the adhesive composition as the need arises. Examples of the other additive include an anion-capturing agent, a dispersing agent, an antioxidant, a silane coupling agent, and a curing promoter. These maybe used alone or in combination of two or more thereof.

The method for producing the adhesive composition is not particularly limited, and may be yielded as a solution of the adhesive composition, for example, by charging the cation-capturing additive into a vessel, optionally charging a thermosetting resin, a thermoplastic resin and other additives thereinto, dissolving these components in an organic solvent, and stirring the components into an even state.

The organic solvent is not particularly limited as far as the solvent is a solvent wherein the components constituting the adhesive composition can be dissolved, mixed or dispersed into an even state and can be used solvents known in the prior art. Examples thereof include dimethylformamide, dimethylacetoamide, N-methylpyrrolidone, ketone solvents such as acetone, methyl ethyl ketone and cyclohexanone, toluene, and xylene. Methyl ethyl ketone, cyclohexanone or the like is preferred since these solvents are quickly dried, and can be inexpensively obtained.

The adhesive sheet according to an embodiment of the invention for producing a semiconductor device (hereinafter referred to merely as the “adhesive sheet”) is produced, for example, as follows: first, a solution of the adhesive composition is prepared; next, the adhesive composition solution is spread in a predetermined thickness onto a substrate separator to form a painted film; and then the painted film is dried under predetermined conditions. The substrate separator may be polyethylene terephthalate (PET), polyethylene or polypropylene; a plastic film or paper sheet that has a surface coated with a remover such as fluorine-contained remover or long-chain alkyl acrylate remover; or some other. The manner for the coating is not particularly limited, and may be, for example, roll coating, screen coating, and gravure coating. Condition for drying is, for example, as follows: the drying temperature is from 70 to 160° C. and the drying time is from 1 to 5 minutes.

By this method, the semiconductor-device-producing adhesive sheet according to the embodiment is yielded.

Since the thus-yielded adhesive sheet contains the cation-capturing additive, the sheet can capture a cation mixed from the outside in various processes in the production of a semiconductor device. As a result, the mixed cation does not easily reach a circuit-forming area formed on the upper surface of a wafer so that deterioration of the electrical property is restrained. Thus, the product reliability of the device can be improved.

In the embodiment, the description has been made about the case of using, as main adhesive components incorporated into the adhesive composition, a thermosetting resin and a thermoplastic resin. In the invention, however, instead of a thermosetting resin and a thermoplastic resin as described above, the following inorganic materials may be incorporated as one or more main adhesive components incorporated into the adhesive composition: a ceramic material, a cement material, solder and/or some other inorganic materials.

The semiconductor-device-producing adhesive sheet is not particularly limited as far as the sheet is a sheet usable to produce a semiconductor device. Examples thereof include a die-bonding film for bonding a semiconductor chip onto an adherend such as a lead frame, a protective film for protecting the rear surface of a semiconductor chip of a flip chip type semiconductor device, and a sealing sheet used for sealing a semiconductor chip.

About the adhesive sheet, it is preferred that the tensile storage modulus at 60° C. before the sheet is thermally cured is 0.01 MPa or more and 1000 MPa or less. The elasticity is more preferably 0.05 MPa or more and 100 MPa or less, even more preferably 0.1 MPa or more and 50 MPa or less. About the adhesive sheet, the tensile storage modulus at 260° C. after the sheet is thermally cured is 0.01 MPa or more and 500 MPa or less. The elasticity is more preferably 0.03 MPa or more and 500 MPa or less, even more preferably 0.05 MPa or more and 100 MPa or less, even more preferably 0.1 MPa or more and 50 MPa or less. When the tensile storage modulus at 60° C. before the thermal curing is 0.01 MPa or more, the sheet can maintain a shape required for a film and provide a good workability. When the tensile storage modulus at 60° C. before the thermal curing is 1000 MPa or less, the sheet can gain a good wettability to an adherend. Meanwhile, when the tensile storage modulus at 260° C. after the thermal curing is 500 MPa or less, the sheet makes it possible to relieve thermal stress generated by a difference in thermal expansion coefficient between a semiconductor chip and an interposer, which is a wiring board.

### EXAMPLES

Below, preferred examples of the present invention are explained in detail. However, materials, addition amounts, and the like described in these examples are not intended to limit the scope of the present invention, and are only examples for explanation as long as there is no description of limitation in particular. Hereinafter, the word “part(s)” means part(s) by weight.

### Example 1

The following components (a) to (f) were dissolved into methyl ethyl ketone to yield an adhesive composition solution having a concentration of 20% by weight:
(a) acrylic ester polymer made mainly from ethyl acrylate and methyl methacrylate (trade name: Paracron W-116.3, manufactured by Negami Chemical Industrial Co., Ltd.): 30 parts,
(b) epoxy resin (trade name: EPICOAT 1004, manufactured by Japan Epoxy Resins Co., Ltd.): 5 parts,
(c) phenolic resin (trade name: MIREX XLC-LL, manufactured by Mitsui Chemicals, Inc.): 5 parts,
(d) polyfunctional epoxy crosslinking agent (trade name: TETRAD-C, manufactured by Mitsubishi Gas Chemical Co., Inc.): 1 part,
(e) silica filler (trade name: SE-2050, manufactured by Admatechs Co., Ltd.: 60 parts, and
(f) nitrogen-containing compound (benzotriazole compound; trade name: BT-120, manufactured by Johoku Chemical Co., Ltd.): 0.5 part.

### Example 2

An adhesive composition solution of Example 2 was yielded in the same way as in Example 1 except that the blend amount of the nitrogen-containing compound (f) was changed to 1 part.

### Example 3

An adhesive composition solution of Example 3 was yielded in the same way as in Example 1 except that the blend amount of the nitrogen-containing compound (f) was changed to 3 parts.

### Example 4

An adhesive composition solution of Example 4 was yielded in the same way as in Example 1 except that the blend amount of the nitrogen-containing compound (f) was changed to 10 parts.

### Example 5

An adhesive composition solution of Example 5 was yielded in the same way as in Example 1 except that the blend amount of the nitrogen-containing compound (f) was changed to 20 parts.

### Example 6

An adhesive composition solution of Example 6 was yielded in the same way as in Example 1 except that the blend amount of the nitrogen-containing compound (f) was changed to 25 parts.

### Example 7

An adhesive composition solution of Example 7 was yielded in the same way as in Example 1 except that instead of the nitrogen-containing compound (f), 0.5 part of a carboxyl-containing aliphatic compound (trade name: CHELEST MZ-8, manufactured by Chelest Corp.) was used.

### Example 8

An adhesive composition solution of Example 8 was yielded in the same way as in Example 7 except that the blend amount of the carboxyl-containing aliphatic compound used in Example 7 was changed to 1 part.

### Example 9

An adhesive composition solution of Example 9 was yielded in the same way as in Example 7 except that the blend amount of the carboxyl-containing aliphatic compound used in Example 7 was changed to 3 parts.

### Example 10

An adhesive composition solution of Example 10 was yielded in the same way as in Example 7 except that the blend amount of the carboxyl-containing aliphatic compound used in Example 7 was changed to 10 parts.

### Example 11

An adhesive composition solution of Example 11 was yielded in the same way as in Example 7 except that the blend amount of the carboxyl-containing aliphatic compound used in Example 7 was changed to 20 parts.

### Example 12

An adhesive composition solution of Example 12 was yielded in the same way as in Example 7 except that the blend amount of the carboxyl-containing aliphatic compound used in Example 7 was changed to 25 parts.

### Example 13

An adhesive composition solution of Example 13 was yielded in the same way as in Example 1 except that instead of the nitrogen-containing compound as described in (f), 5 parts of an inorganic cation exchanger (trade name: IXE-770, manufactured by Toagosei Co., Ltd.; average particle diameter: 6.29 μm) were used.

### Example 14

An adhesive composition solution of Example 14 was yielded in the same way as in Example 13 except that the blend amount of the inorganic cation exchanger used in Example 13 was changed to 10 parts.

### Example 15

An adhesive composition solution of Example 15 was yielded in the same way as in Example 13 except that the blend amount of the inorganic cation exchanger used in Example 13 was changed to 20 parts.

### Example 16

An adhesive composition solution of Example 16 was yielded in the same way as in Example 13 except that the blend amount of the inorganic cation exchanger used in Example 13 was changed to 25 parts.

### Comparative Example 1

The following components (a) to (e) were dissolved into methyl ethyl ketone to yield an adhesive composition having a concentration of 20% by weight:
(a) acrylic ester polymer made mainly from ethyl acrylate and methyl methacrylate (trade name: Paracron W-116.3, manufactured by Negami Chemical Industrial Co., Ltd.): 30 parts,
(b) epoxy resin (trade name: EPICOAT 1004, manufactured by Japan Epoxy Resins Co., Ltd.): 5 parts,
(c) phenolic resin (trade name: MIREX XLC-LL, manufactured by Mitsui Chemicals, Inc.): 5 parts,
(d) polyfunctional epoxy crosslinking agent (trade name: TETRAD-C, manufactured by Mitsubishi Gas Chemical Co., Inc.): 1 part, and
(e) silica filler (trade name: SE-2050, manufactured by Admatechs Co., Ltd.): 60 parts.

### Comparative Example 2

An adhesive composition solution of Comparative Example 2 was yielded in the same way as in Comparative Example 1 except that 10 parts of an anion exchanger (trade name: IXE-550, manufactured by Toagosei Co., Ltd.) were further added to the adhesive composition of Comparative Example 1.

### Comparative Example 3

An adhesive composition solution of Comparative Example 3 was yielded in the same way as in Comparative Example 1 except that 20 parts of an anion exchanger (trade name: IXE-550, manufactured by Toagosei Co., Ltd.) were further added to the adhesive composition of Comparative Example 1.

### Example 17

The following components (a) to (e) were dissolved into methyl ethyl ketone to yield an adhesive composition having a concentration of 20% by weight:
(a) acrylic ester polymer made mainly from ethyl acrylate and methyl methacrylate (trade name: SG-70L, manufactured by Nagase ChemteX Corp.): 40 parts,
(b) epoxy resin (trade name: KI-3000, manufactured by Tohto

Kasei Co., Ltd.): 5 parts,
(c) phenolic resin (trade name: MEH-7851H, manufactured by Meiwa Plastic Industries, Ltd.): 5 parts,
(d) silica filler (trade name: SO-E3, manufactured by Admatechs Co., Ltd.): 50 parts, and
(e) hydroxyl-containing compound (hydroxyquinone compound, i.e., alizarin, manufactured by Tokyo Chemical Industry Co., Ltd.): 3 parts.

### Example 18

The following components (a) to (e) were dissolved into methyl ethyl ketone to yield an adhesive composition having a concentration of 20% by weight:
(a) acrylic ester polymer made mainly from ethyl acrylate and methyl methacrylate (trade name: SG-70L, manufactured by Nagase ChemteX Corp.): 40 parts,
(b) epoxy resin (trade name: KI-3000, manufactured by Tohto Kasei Co., Ltd.): 5 parts,
(c) phenolic resin (trade name: MEH-7851H, manufactured by Meiwa Plastic Industries, Ltd.): 5 parts,
(d) silica filler (trade name: SO-E3, manufactured by Admatechs Co., Ltd.): 50 parts, and
(e) carboxyl-containing compound (carboxyl-containing aliphatic compound, i.e., stearic acid, manufactured by Tokyo Chemical Industry Co., Ltd.): 3 parts.

### Example 19

The following components (a) to (e) were dissolved into methyl ethyl ketone to yield an adhesive composition having a concentration of 20% by weight:
(a) acrylic ester polymer made mainly from ethyl acrylate and methyl methacrylate (trade name: SG-70L, manufactured by Nagase ChemteX Corp.): 40 parts,
(b) epoxy resin (trade name: KI-3000, manufactured by Tohto Kasei Co., Ltd.): 5 parts,
(c) phenolic resin (trade name: MEH-7851H, manufactured by Meiwa Plastic Industries, Ltd.): 5 parts,
(d) silica filler (trade name: SO-E3, manufactured by Admatechs Co., Ltd.): 50 parts, and
(e) nitrogen-containing compound (nitrogen-containing compound, i.e., bipyridyl, manufactured by Tokyo Chemical Industry Co., Ltd.): 3 parts.

### Example 20

The following components (a) to (e) were dissolved into methyl ethyl ketone to yield an adhesive composition having a concentration of 20% by weight:
(a) acrylic ester polymer made mainly from ethyl acrylate and methyl methacrylate (trade name: SG-70L, manufactured by Nagase ChemteX Corp.): 40 parts,
(b) epoxy resin (trade name: KI-3000, manufactured by Tohto Kasei Co., Ltd.): 5 parts,
(c) phenolic resin (trade name: MEH-7851H, manufactured by Meiwa Plastic Industries, Ltd.): 5 parts,
(d) silica filler (trade name: SO-E3, manufactured by Admatechs Co., Ltd.): 50 parts, and
(e) nitrogen-containing compound (nitrogen-containing compound, i.e., bipyridyl, manufactured by Tokyo Chemical Industry Co., Ltd.): 10 parts.

### Example 21

The following components (a) to (e) were dissolved into methyl ethyl ketone to yield an adhesive composition having a concentration of 20% by weight:
(a) acrylic ester polymer made mainly from ethyl acrylate and methyl methacrylate (trade name: SG-70L, manufactured by Nagase ChemteX Corp.): 40 parts,
(b) epoxy resin (trade name: KI-3000, manufactured by Tohto Kasei Co., Ltd.): 5 parts,
(c) phenolic resin (trade name: MEH-7851H, manufactured by Meiwa Plastic Industries, Ltd.): 5 parts,
(d) silica filler (trade name: SO-E3,manufactured by Admatechs Co., Ltd.): 50 parts, and
(e) nitrogen-containing compound (trade name: TINUVIN 928, manufactured by BASF): 3 parts.

### Example 22

The following components (a) to (e) were dissolved into methyl ethyl ketone to yield an adhesive composition having a concentration of 20% by weight:
(a) acrylic ester polymer made mainly from ethyl acrylate and methyl methacrylate (trade name: SG-70L, manufactured by Nagase ChemteX Corp.): 40 parts,
(b) epoxy resin (trade name: KI-3000, manufactured by Tohto Kasei Co., Ltd.): 5 parts,
(c) phenolic resin (trade name: MEH-7851H, manufactured by Meiwa Plastic Industries, Ltd.): 5 parts,
(d) silica filler (trade name: SO-E3, manufactured by Admatechs Co., Ltd.): 50 parts, and
(e) nitrogen-containing compound (trade name: TINUVIN 928, manufactured by BASF): 10 parts.
   Measurement of each Tensile Storage Modulus at 60° C. Before Thermal Curing:

The adhesive composition solution according to Example 1 was spread onto each releasing-treatment-subjected film (peeling liner) made of a polyethylene terephthalate film, 50 μm in thickness, subjected to silicone releasing treatment. The solution-coated films were each dried at 130° C. for 2 minutes. In this way, adhesive sheets each having a thickness of 100 μm were formed. In the same way as described above, each of the adhesive composition solutions according to Examples 2 to 22 and Comparative Example 1 to 3 was spread onto each releasing-treatment-subjected film. The solution-painted films were each dried at 130° C. for 2 minutes to form adhesive sheets each having a thickness of 100 μm. The individual adhesive sheets formed in each of the examples and the comparative examples were bonded together, and then the resultant was cut into a sample having a length of 30 mm, a width of 10 mm and a thickness of 0.20 mm. Next, the tensile storage modulus of each of the samples were measured with a viscoelastometer (trade name: RSA-II, manufactured by Reometric Scientific F.E. Corp.) in the temperature range of −40 to 300° C. under the following conditions: a frequency of 1 Hz, a strain amount of 0.1%, and a temperature-raising rate of 10° C./minute. The values measured at 60° C. are shown in Tables 1 and 2.

Measurement of each Tensile Storage Modulus at 260° C. After Thermal Curing:

In the same way as in the measurement of each of the tensile storage modulus at 60° C. before the thermal curing, adhesive sheets (thickness: 100 μm) of each of Example 1 to 22 and Comparative Examples 1 to 3 were formed. The adhesive sheets were allowed to standstill in an oven of 175° C. temperature for 1 hour, and then the tensile storage modulus of each of the examples and the comparative examples were measured at 260° C. with the viscoelastometer (trade name: RSA-II, manufactured by Reometric Scientific F.E. Corp.) after the thermal curing. In the measurement, measuring samples were used, which prepared as the following procedure: the adhesive sheets formed in each of the examples and the comparative examples were bonded together, the resultant was cut into a sample having a length of 30 mm, a width of 10 mm and a thickness of 0.20 mm to be a measuring sample. The tensile storage modulus was measured in the temperature range of −40 to 300° C. under the following conditions: a frequency of 1 Hz, a strain amount of 0.1%, and a temperature-raising rate of 10° C./minute. The values measured at 260° C. are shown in Tables 1 and 2.

Measurement of each Ionic Impurity Concentration:

The adhesive composition solution according to Example 1 was spread onto a releasing-treatment-subjected film (peeling liner) made of a polyethylene terephthalate film, 50 μm in thickness, subjected to silicone releasing treatment. The solution-coated film was dried at 130° C. for 2minutes. In this way, an adhesive sheet having a thickness of 20 μm was formed. In the same way as described above, each of the adhesive composition solutions according to Examples 2 to 22 and Comparative Example 1 to 3 was spread onto a releasing-treatment-subjected film. The solution-painted film was dried at 130° C. for 2 minutes to form an adhesive sheet having a thickness of 20 μm.

Each of the adhesive sheets (thickness: 20 μm) was cut into a size of 240 mm×300 mm (weight: about 2.5 g), and the cut sheet was folded into half 5 times. The resultant, the folded sheet with a size of 37.5 mm×60 mm, was put into an airtight container made of Teflon (registered trade name) and having a diameter of 58 mm and a height of 37 mm, and then 50 mL of a 10-ppm Cu (II) ion solution in water was put into the container. Thereafter, the container was allowed to stand still in a constant temperature dryer (trade name: PV-231, manufactured by Espec Corp.) at 120° C. for 20 hours. The film was taken out therefrom, and then the copper ion concentration in the aqueous solution was measured with a device, ICP-AES (trade name: SPS-1700HVR, manufactured by SII Nano Technology Inc.). The results are shown in Tables 1 and 2.

### Results:

As understood from the results in Tables 1 and 2, the adhesive sheets each made of the composition containing the cation-capturing additive were each able to capture Cu (II) ions. However, the adhesive sheet such as Comparative Example 1, which was made of the adhesive composition containing no cation-capturing additive, was unable to capture Cu (II) ions sufficiently. The adhesive sheets of Comparative such as Examples 2 and 3, which were each made of the anion-exchanger-containing adhesive composition, were unable to capture Cu (II) ions sufficiently, either.

TABLE 1

| | Example | Example | Example | Example | Example |
|---|---|---|---|---|---|
| | 1 | 2 | 3 | 4 | 5 |
| Tensile storage modulus (MPa) at | 15.4 | 11.8 | 5.13 | 29 | 3.37 |
| 60° C. before thermal curing | | | | | |
| Tensile storage modulus (MPa) at | 77.8 | 11.6 | 8.44 | 0.365 | 0.104 |
| 260° C. after thermal curing | | | | | |
| Copper (II) ion concentration (ppm) | 9.62 | 9.59 | 9.55 | 0.382 | 0.124 |
| | Example | Example | Example | Example | Example |
| | 6 | 7 | 8 | 9 | 10 |
| Tensile storage modulus (MPa) at | 1.37 | 39.9 | 25.1 | 8.34 | 10.1 |
| 60° C. before thermal curing | | | | | |
| Tensile storage modulus (MPa) at | 0.0243 | 9.8 | 10.2 | 6.02 | 4.82 |
| 260° C. after thermal curing | | | | | |
| Copper (II) ion concentration (ppm) | 0.114 | 9.86 | 9.77 | 9.6 | 9.68 |
| | Example | Example | Example | Example | Example |
| | 11 | 12 | 13 | 14 | 15 |
| Tensile storage modulus (MPa) at | 5.23 | 4.15 | 5.16 | 6.05 | 11.6 |
| 60° C. before thermal curing | | | | | |
| Tensile storage modulus (MPa) at | 11.3 | 15.2 | 3.74 | 4.65 | 14.3 |
| 260° C. after thermal curing | | | | | |
| Copper (II) ion concentration (ppm) | 9.39 | 8.9 | 8.79 | 6.28 | 1.56 |

| | Example | Comparative | Comparative | Comparative |
|---|---|---|---|---|
| | 16 | Example 1 | Example 2 | Example 3 |
| Tensile storage modulus (MPa) at | 13.1 | 14.2 | 10.4 | 21 |
| 60° C. before thermal curing | | | | |
| Tensile storage modulus (MPa) at | 23 | 4.62 | 21 | 34.2 |
| 260° C. after thermal curing | | | | |
| Copper (II) ion concentration (ppm) | 1.01 | 10.1 | 10.1 | 9.89 |

TABLE 2

| | Example | Example | Example | Example | Example | Example |
|---|---|---|---|---|---|---|
| | 17 | 18 | 19 | 20 | 21 | 22 |
| Tensile storage modulus (MPa) at | 8.97 | 7.02 | 4.99 | 3.78 | 3.52 | 1.9 |
| 60° C. before thermal curing | | | | | | |
| Tensile storage modulus (MPa) at | 2.09 | 1.8 | 8.12 | 10.2 | 1.56 | 1.45 |
| 260° C. after thermal curing | | | | | | |
| Copper (II) ion concentration (ppm) | 3.19 | 8.66 | 9.17 | 7.97 | 7.97 | 5.15 |

1. An adhesive composition for producing a semiconductor device comprising at least an additive for capturing a cation.

2. The adhesive composition according to claim 1, wherein the additive is a cation exchanger or a complexing compound.

3. The adhesive composition according to claim 2, wherein the cation exchanger is an inorganic cation exchanger.

4. The adhesive composition according to claim 3, wherein the inorganic cation exchanger is an oxidized hydrate of an element selected from the group consisting of antimony, bismuth, zirconium, titanium, tin, magnesium, and aluminum.

5. The adhesive composition according to claim 3, wherein the inorganic cation exchanger has an average particle diameter of 0.05 to 20 μm.

6. The adhesive composition according to claim 2, wherein the complexing compound is an organic complexing compound.

7. The adhesive composition according to claim 6, wherein the organic complexing compound is one or more selected from the group consisting of a nitrogen-containing compound, a hydroxyl-containing compound, and a carboxyl-containing compound.

8. The adhesive composition according to claim 7, wherein the nitrogen-containing compound is one or more selected from the group consisting of triazole compounds, tetrazole compounds, pyridyl compounds, and triazine compounds.

9. The adhesive composition according to claim 7, wherein the hydroxyl-containing compound is one or more selected from the group consisting of quinol compounds, hydroxyanthraquinone compounds, and polyphenolic compounds.

10. The adhesive composition according to claim 7, wherein the carboxyl-containing compound is one or more selected from the group consisting of carboxyl-containing aromatic compounds, and carboxyl-containing aliphatic compounds.

11. The adhesive composition according to claim 1, wherein the content of the additive ranges from 0.01 to 80 parts by weight for 100 parts by weight of the adhesive composition.

12. An adhesive sheet for producing a semiconductor device, the adhesive sheet being formed by use of an adhesive composition according to claim 1.

13. The adhesive composition according to claim 4, wherein the inorganic cation exchanger has an average particle diameter of 0.05 to 20 μm.

14. A semiconductor device apparatus, comprising a semiconductor device in contact with the adhesive sheet of claim 12.

15. The adhesive composition according to claim 1, wherein the content of the additive ranges from 0.5 to 80 parts by weight for 100 parts by weight of the adhesive composition.

16. The adhesive composition according to claim 1, wherein the content of the additive ranges from 1 to 80 parts by weight for 100 parts by weight of the adhesive composition.

17. The adhesive composition according to claim 1, wherein the content of the additive ranges from 3 to 80 parts by weight for 100 parts by weight of the adhesive composition.

18. The adhesive composition according to claim 1, wherein the content of the additive ranges from 10 to 80 parts by weight for 100 parts by weight of the adhesive composition.
